(19) United States
(12) Patent Application Publication
(10) Pub. No.: US 2026/0351888 A1
(43) Pub. Date: Nov. 5, 2026

(54) COVER SYSTEM FOR VEHICLE CHARGING WALL CONNECTOR

(71) Applicant: LM4 Enterprises, Inc., Oakwood, GA (US)

(72) Inventors: William Lee McDowell, IV, Oakwood, GA (US); Yunfan Lin, Duluth, GA (US); Randall Marc Bachtel, Lawrenceville, GA (US); Stephen Lawrence Phelps, Lilburn, GA (US); Peter Wyndham Shipp, JR., Woodstock, GA (US)

(21) Appl. No.: 19/195,069

(22) Filed: Apr. 30, 2025

(51) Int. Cl. H01R 13/447; B60L 53/18; B60L 53/30; H01R 13/717; H01R 13/72

(52) U.S. Cl. CPC H01R 13/447; B60L 53/18; B60L 53/30; H01R 13/7172; H01R 13/7175; H01R 13/72

(57) ABSTRACT

A system for enhancing an electric vehicle charging apparatus may include a cover configured to enclose an electric vehicle wall connector without compromising functionality of the wall connector. The system may include a plurality of mounting brackets configured to secure the cover to a wall adjacent to the wall connector without requiring removal of a glass cover of the wall connector. The system may include at least one light pipe configured to collect light emissions from light emitting diodes of the wall connector and transmit the light emissions to a visible exterior portion of the cover. The system may include a sliding door mechanism integrated with the cover, the sliding door mechanism providing access to a vehicle connector storage area of the wall connector.

### FIELD OF DISCLOSURE

The present disclosure generally relates to electric vehicle charging infrastructure and accessories. More specifically, the present disclosure relates to customizable cover systems for wall-mounted electric vehicle charging connectors.

### BACKGROUND

In some situations, electric vehicle charging wall connectors have limited aesthetic customization options. For example, wall-mounted charging units typically come in standard colors and designs that may not match the desired décor of a garage or charging location. Thus, the conventional strategy is to use the charging unit as provided by the manufacturer without modification. This often causes problems because the conventional strategy does not allow users to personalize or customize the appearance of their charging infrastructure. For example, charging units can appear utilitarian and industrial, detracting from carefully designed interior spaces. Additionally, attempting to modify or cover existing charging units can interfere with important functional elements like status indicators and cable management features.

In some situations, wall-mounted charging units lack adequate protection from environmental factors in outdoor installations. For example, exposure to rain, snow, UV radiation and temperature fluctuations can degrade the appearance and functionality of charging equipment over time. The conventional strategy relies on basic weather resistance built into the charging unit itself. This often causes problems because the conventional strategy does not provide sufficient shielding from harsh environmental conditions. For example, extended sun exposure can cause fading and deterioration of plastic components.

In other situations, wall-mounted charging units create visual clutter in carefully designed spaces. For example, industrial-looking charging equipment can disrupt the aesthetic harmony of upscale residential garages or commercial charging locations. The conventional strategy involves accepting the standard utilitarian appearance of charging infrastructure. This often causes problems because the conventional strategy does not allow the charging equipment to blend seamlessly with surrounding décor. For example, standard charging units typically feature basic monochromatic designs that may clash with custom interior finishes.

Additionally, wall-mounted charging units frequently lack proper cable management solutions. For example, charging cables can become tangled or lay on the ground when not in use, creating both safety hazards and an untidy appearance. The conventional strategy relies on basic cable hooks or holders integrated into the charging unit. This often causes problems because the conventional strategy does not adequately contain and organize charging cables. For example, cables may still drag on the ground or become twisted, potentially leading to damage over time.

Current wall-mounted charging units lack effective weatherproofing capabilities for outdoor installations. For example, harsh environmental conditions like rain, snow, UV radiation and temperature fluctuations can degrade charging equipment over time. The conventional strategy relies on basic weather resistance built into the charging unit itself. This often causes problems because the conventional strategy does not sufficiently protect sensitive components from environmental damage. For example, extended exposure to sun and moisture can lead to deterioration of plastic parts and electrical connections.

Wall-mounted charging units frequently create visual disruption in carefully designed spaces. For example, industrial-looking charging equipment can clash with upscale residential or commercial interiors. The conventional strategy involves accepting the standard utilitarian appearance of charging infrastructure. This often causes problems because the conventional strategy does not allow charging equipment to complement existing décor. For example, basic monochromatic charging units may detract from custom interior finishes and architectural elements.

Additionally, wall-mounted charging units have inadequate cable management. For example, charging cables can become tangled or lay on the ground when not in use, creating both safety hazards and an untidy appearance. The conventional strategy uses basic integrated cable hooks. This often causes problems because the conventional strategy does not effectively contain and organize charging cables. For example, cables may still drag on the ground or become twisted, potentially leading to damage over time.

There is an increasing need for better protection and organization of charging infrastructure in both residential and commercial settings. For example, current wall-mounted charging units often lack comprehensive solutions for managing cables, protecting sensitive components, and maintaining aesthetic appeal over time. The conventional charging units typically focus solely on basic charging functionality without addressing these auxiliary needs. This often causes problems because the conventional strategy leaves critical aspects of charging infrastructure management unaddressed. For example, users must deal with exposed cables, weather damage, and visual clutter that can detract from carefully designed spaces.

### BRIEF OVERVIEW

This brief overview is provided to introduce a selection of concepts in a simplified form that are further described below in the Detailed Description. This brief overview is not intended to identify key features or essential features of the claimed subject matter. Nor is this brief overview intended to be used to limit the claimed subject matter's scope.

A system for enhancing an electric vehicle charging apparatus may comprise a cover configured to enclose an electric vehicle wall connector without compromising functionality of the wall connector. The system may include a plurality of mounting brackets configured to secure the cover to a wall adjacent to the wall connector without requiring removal of a glass cover of the wall connector. The system may include at least one light pipe configured to collect light emissions from light emitting diodes of the wall connector and transmit the light emissions to a visible exterior portion of the cover. The system may include a sliding door mechanism integrated with the cover, the sliding door mechanism providing access to a vehicle connector storage area of the wall connector.

A system for customizing an appearance of an electric vehicle charging station may comprise a wall-mountable enclosure having an angular design. The system may include a plurality of L-shaped mounting brackets configured to secure the enclosure to a wall surface without requiring disassembly of an electric vehicle wall connector. The system may include a light transmission assembly comprising at least one light pipe configured to redirect status indicator lights from the wall connector to a viewing slot on the enclosure. The system may include an access door integrated into a side of the enclosure, the access door being slidable to provide access to a charging cable connector storage area.

A system for retrofitting an electric vehicle wall charging unit may comprise a housing having an interior cavity sized to accommodate an existing wall-mounted electric vehicle charging unit. The system may include a mounting assembly comprising a plurality of upper L-shaped brackets configured to be secured to a wall above the charging unit, a plurality of lower brackets configured to be secured to the wall below the charging unit, and fastening elements configured to secure the housing to the mounting assembly. The system may include a light transmission system comprising at least one light conduit configured to transmit status indicator lights from the charging unit to a viewing area on the housing. The system may include a movable access panel integrated with the housing, the movable access panel providing access to a charging connector storage area of the charging unit.

Both the foregoing brief overview and the following detailed description provide examples and are explanatory only. Accordingly, the foregoing brief overview and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicant. In addition, the drawings may contain other marks owned by third parties and are being used for illustrative purposes only. All rights to various trademarks and copyrights represented herein, except those belonging to their respective owners, are vested in and the property of the Applicant. The Applicant retains and reserves all rights in its trademarks and copyrights included herein, and grants permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure. In the drawings:

FIG. 1 illustrates a front perspective view of a cover system for an electric vehicle wall connector according to an embodiment of the present disclosure;

FIG. 2 illustrates a left side view of the cover shown in FIG. 1;

FIG. 3 illustrates a right side view of the cover shown in FIG. 1;

FIG. 4 illustrates a top view of the cover shown in FIG. 1;

FIG. 5 illustrates a bottom view of the cover shown in FIG. 1;

FIG. 6 illustrates a detail view showing a sliding door in the first side of the cover shown in FIG. 1;

FIG. 7 illustrates a partial rear perspective view of the cover shown in FIG. 1, with the sliding door in a closed configuration;

FIG. 8 illustrates a partial rear perspective view of the cover shown in FIG. 1, with the sliding door in an open configuration;

FIG. 9 illustrates a rear perspective view of the cover system shown in FIG. 1, including the mounting system, with the sliding door in a closed configuration;

FIG. 10 illustrates a rear perspective view of the cover system shown in FIG. 1, including the mounting system, with the sliding door in an open configuration;

FIG. 11 illustrates a first embodiment of a light transmission system for use in the cover system shown in FIG. 1;

FIG. 12 illustrates a second embodiment of a light transmission system for use in the cover system shown in FIG. 1; and

FIG. 13 is a flow chart of a method for providing a cover system for an electric vehicle wall connector.

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure and are made merely to provide a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such a term to mean based on the contextual use of the term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Regarding applicability of 35 U.S.C. § 112, ¶6, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subject matter disclosed under the header.

The present disclosure may address the technical problem of limited aesthetic customization options for electric vehicle charging apparatus. Electric vehicle wall connectors, such as those used for Tesla vehicles, may be manufactured with standardized appearances that do not allow users to personalize or customize the look of their charging equipment without potentially compromising the functionality or safety of the unit. This standardization may create a utilitarian appearance that may not harmonize with users' preferences for home décor, garage aesthetics, and/or personal style expressions.

Wall connectors may typically include critical functional elements such as status indicator lights, cable management systems, and connector storage areas. These elements may provide essential feedback and utility to users during the charging process. Any attempt to modify the appearance of such wall connectors may risk interfering with these functions or may require technical expertise beyond that of the average user. Additionally, modifications that require disassembly of the wall connector may void warranties or create electrical safety concerns due to the high current loads involved in electric vehicle charging.

The system described herein may provide a solution by offering a cover that may be installed over an existing electric vehicle wall connector without requiring disassembly of the original unit or disconnection from power sources. The cover may maintain all essential functions of the original wall connector while transforming its external appearance to suit user preferences.

In a residential garage scenario, a homeowner may wish to coordinate their electric vehicle charging equipment with their home's architectural style. The cover may be provided in designs that complement modern, traditional, or transitional home aesthetics. For example, a homeowner with contemporary décor may select a cover with angular, geometric styling reminiscent of modern design trends. The cover may be mounted over their existing wall connector using the mounting brackets without requiring any modification to the wall connector itself. The light pipes may transmit the status indicator lights from the wall connector to the visible exterior of the cover, maintaining the functional feedback mechanism while enhancing the visual appeal of the charging station.

In a commercial setting, such as a hotel or restaurant offering electric vehicle charging as an amenity, the establishment may wish to incorporate their branding into the charging equipment. The cover may be customized with corporate colors, logos, and/or designs that align with the establishment's brand identity. The sliding door mechanism may provide guests with access to the vehicle connector storage area while maintaining a cohesive branded appearance. This application may enhance the perceived value of the charging amenity while preserving all functional aspects of the original wall connector.

For sports enthusiasts or fans, the cover may be provided in designs featuring team colors and logos. A sports fan may install the cover over their wall connector to display their team allegiance in their garage or carport. The light transmission system may ensure that charging status information may remain visible through the cover, while the mounting system may secure the cover without requiring removal of the wall connector's glass cover. This may allow seasonal changes or updates to the appearance without affecting the charging functionality.

In multi-unit residential buildings where multiple charging stations may be installed in common parking areas, the covers may be used to differentiate charging stations assigned to specific residents. Each unit owner may have a distinctively styled or colored cover installed over their assigned wall connector, facilitating easy identification while maintaining consistent functionality across all charging stations. The mounting brackets may be installed without disrupting the building's electrical infrastructure or requiring specialized electrical expertise.

In one use case involving Tesla Wall Connectors, the installation process may begin with the selection of the appropriate template corresponding to the specific model of wall connector. The template may be positioned on the wall surrounding the existing wall connector without requiring disconnection of the unit from power sources. This may allow for precise positioning of the mounting brackets without disrupting charging capabilities.

The L-shaped mounting brackets may be installed according to the template guidance, with two mounting brackets positioned above the wall connector and two smaller brackets positioned below. The top surface of the upper mounting brackets may be covered with hook and loop material for securing to corresponding material on the inner surface of the cover. This attachment method may facilitate easy installation and potential removal without permanent modification to the wall or charging equipment.

The cover, which may optionally feature an angular design reminiscent of the Tesla Cyber Truck aesthetic, may be positioned over the wall connector and aligned with the mounted brackets. The cover may then be slid downward to engage the hook and loop attachment at the top while the lower portion may be secured with screws through designated access points. This two-stage attachment process may ensure secure mounting while allowing for potential removal or replacement.

The light pipes, which may be custom-fabricated to match the surface geometry of the specific wall connector model, may collect light emissions from the LED indicators on the wall connector and transmit them to the front display slit of the cover. This light transmission system may preserve the visual feedback function of the original equipment while integrating it into the new aesthetic design.

The sliding door mechanism integrated into the side of the cover may provide access to the connector storage area of the wall connector. This feature may maintain the original cable management functionality while adapting it to the new exterior design. The charging cable may be coiled around the cover or managed through alternative means without compromising the cable storage capabilities of the original wall connector.

Power cable access may be maintained through a cutout at the base of the cover, ensuring that electrical connections may remain undisturbed during and after installation. The cover may be designed to maintain proper ventilation and thermal management for the enclosed wall connector, preventing any potential overheating issues that might arise from enclosing the original equipment.

Through this comprehensive approach, the cover system may transform the appearance of the electric vehicle charging apparatus while preserving all functional aspects and safety features of the original wall connector. This may enable users to personalize their charging equipment without compromising the technical performance or risking electrical safety concerns associated with more invasive modification methods.

The technical advantages of the cover system for electric vehicle charging apparatus may be appreciated through several key benefits that enhance both the aesthetic and functional aspects of standard wall connectors.

The cover system may provide significant thermal management advantages through its carefully designed ventilation features. These ventilation features may maintain proper airflow around the enclosed wall connector during high-current charging operations, which may prevent potential overheating issues. By ensuring adequate heat dissipation, the cover system may contribute to the longevity and reliability of the wall connector while maintaining safety during operation. The ventilation design may be integrated seamlessly with the aesthetic elements of the cover, providing both form and function without compromise.

Another technical advantage may be found in the non-invasive installation method. The cover system may be installed without requiring disconnection of the wall connector from power sources or removal of the glass cover. This installation approach may eliminate electrical safety risks associated with user modification of high-voltage equipment. The mounting system utilizing L-shaped brackets and hook and loop fastening materials may provide secure attachment while allowing for potential removal or replacement without permanent modification to the wall surface or charging equipment. This reversible installation method may preserve manufacturer warranties and safety certifications of the original wall connector.

The light transmission system may offer technical advantages through its efficient collection and redirection of status indicator lights. The custom-shaped light pipes may be precisely engineered to match the specific surface geometry of different wall connector models, ensuring optimal light collection efficiency. This system may maintain color fidelity and visibility of sequential lighting patterns, preserving the critical visual feedback function of the original equipment. The transmission of status information to the display slit on the cover may allow users to monitor charging status without compromising the enhanced aesthetic appearance.

The sliding door mechanism may provide technical advantages through its space-efficient design. The door may slide along a track system integrated into the cover, requiring minimal clearance for operation compared to hinged doors that need swing space. This compact operation may be particularly valuable in tight installation environments such as narrow garages or crowded utility areas. The sliding mechanism may include door stop features to prevent over-travel, ensuring reliable operation over extended use periods.

The cover system may offer enhanced weather protection advantages for wall connectors installed in outdoor environments. The cover may provide an additional barrier against rain, snow, dust, and direct sunlight, potentially extending the service life of the enclosed wall connector. The materials selected for the cover may be engineered to withstand environmental factors such as UV radiation, temperature fluctuations, and humidity without degradation of appearance or functional properties.

The cable management provisions may provide technical advantages through improved organization and safety. The exterior surface of the cover may be designed to facilitate proper coiling of the charging cable when not in use, reducing trip hazards and potential cable damage from improper storage. This organized cable management may prevent excessive strain on cable connection points, potentially extending the service life of the charging cable. The system may accommodate various cable routing options to suit different installation environments while maintaining accessibility for daily use.

The modular design approach may offer technical advantages through customization flexibility. The basic functional elements of the cover system may remain consistent across different aesthetic variants, ensuring reliable performance regardless of the chosen design. This modular approach may allow for future design updates or replacements without requiring modification of the mounting system or light transmission components. Users may potentially change the cover to match seasonal themes, updated home décor, or new preferences without disrupting the charging infrastructure.

The cover system may provide ergonomic advantages through thoughtful user interface design. The height of the display slit may be positioned for optimal visibility from typical user viewing angles. The sliding door mechanism may be designed for ease of operation with minimal force requirements. The cable management provisions may be positioned to facilitate convenient coiling and uncoiling of the charging cable with natural hand movements. These ergonomic considerations may enhance the overall user experience with the charging equipment.

The power conductor cutout may offer technical advantages through strain relief for the power cable. The cutout may be precisely sized and positioned to accommodate the power cable without creating pressure points or sharp bends that could damage the cable insulation over time. This careful design may prevent potential electrical hazards associated with damaged power cables and may extend the service life of the electrical connections.

The cover system may provide acoustic advantages by potentially reducing operational noise from the wall connector. The additional enclosure may dampen any minor vibrations or electronic humming that might be produced during charging operations. This noise reduction may be particularly valuable in residential settings where the wall connector may be installed near living spaces or bedrooms.

The present disclosure includes many aspects and features. Moreover, while many aspects and features relate to, and are described in, the context of a cover for an electrical vehicle charging station, embodiments of the present disclosure are not limited to use only in this context.

### I. Platform Overview

This overview is provided to introduce a selection of concepts in a simplified form that are further described below. This overview is not intended to identify key features or essential features of the claimed subject matter. Nor is this overview intended to be used to limit the claimed subject matter's scope.

The present disclosure may relate to a cover system for an electric vehicle charging apparatus, particularly wall connectors used for charging electric vehicles. This system may provide a solution to the limited aesthetic customization options available for standard electric vehicle wall connectors without compromising their essential functionality. The cover may be installed over an existing wall connector without requiring disassembly of the original unit or disconnection from power sources, thereby preserving warranty coverage and maintaining electrical safety.

The cover system may include a main housing designed to enclose the existing wall connector while maintaining access to all functional components. This housing may feature a distinctive aesthetic design, such as an angular style reminiscent of modern automotive trends. The system may utilize a set of mounting brackets that attach to the wall surrounding the existing wall connector, providing secure attachment points for the cover without modifying the wall connector itself.

An aspect of the system may be the light transmission mechanism, which may employ specially designed light pipes that collect light emissions from the status indicator LEDs on the original wall connector and transmit them to a visible display slit on the front surface of the cover. This feature may preserve the essential visual feedback function of the wall connector while integrating it into the new aesthetic design.

The system may also incorporate a sliding door mechanism that provides access to the connector storage area of the original wall connector, maintaining the cable management functionality while adapting it to the new exterior design. The cover may include provisions for power cable routing and may be designed to maintain proper ventilation for the enclosed wall connector to prevent potential overheating issues.

Installation of the cover may be facilitated through the use of model-specific templates that guide the positioning of mounting brackets. The attachment method may utilize hook and loop fastening materials at the upper portion of the cover and screw fasteners at the lower portion, creating a secure mounting system that may be removed if desired without permanent modification to the wall or charging equipment.

The cover system may transform the appearance of the electric vehicle charging apparatus while preserving all functional aspects and safety features of the original wall connector. This may enable users to personalize their charging equipment according to their aesthetic preferences, coordinate with home décor, display team affiliations, or incorporate branding elements in commercial applications, all without compromising the technical performance or safety of the charging equipment.

Both the foregoing overview and the following detailed description provide examples and are explanatory only. Accordingly, the foregoing overview and the following detailed description should not be considered to be restrictive. Further, features or variations may be provided in addition to those set forth herein. For example, embodiments may be directed to various feature combinations and sub-combinations described in the detailed description.

### II. Platform Configuration

The cover system for an electric vehicle charging apparatus may operate within various environmental contexts that influence its design, installation, and/or functionality. The operating environment may include residential, commercial, and institutional settings where electric vehicle charging stations, specifically wall-mounted charging connectors, are installed.

In residential applications, the cover system may be employed in garages, carports, or exterior wall locations where homeowners have installed electric vehicle wall connectors. These environments may vary significantly in terms of temperature, humidity, and exposure to elements, particularly for outdoor installations. The cover system may be designed to withstand these environmental variations while maintaining both aesthetic appeal and functional integrity. Residential installations may also present space constraints, with wall connectors often positioned in proximity to vehicles, storage items, or other garage fixtures, requiring the cover system to maintain a compact profile that does not impede movement or access.

For commercial deployments, the cover system may function in parking structures, public charging stations, corporate campuses, or retail locations where multiple charging units may be installed. These environments may experience higher traffic volumes and more frequent usage patterns compared to residential settings. The cover system may be engineered to withstand this increased usage while providing opportunities for commercial branding or informational displays. Commercial settings may also impose specific requirements regarding visibility, accessibility, and compliance with facility design standards that the cover system may accommodate.

The electrical infrastructure supporting high-current charging may constitute an important aspect of the operating environment. The cover system may be designed to function with various wall connector models that operate at varying voltage and/or current specifications. This electrical environment may necessitate specific safety considerations in the cover design, including proper ventilation to prevent heat buildup, adequate clearance around electrical components, and non-conductive materials selection. The cover system may be engineered to maintain compatibility with the electrical safety features of the original wall connector without introducing new electrical hazards.

The wall surfaces where charging units are mounted may represent another environmental factor. These surfaces may vary in material composition (drywall, concrete, wood, metal, etc.), texture, and/or structural integrity. The mounting system of the cover may be adaptable to these different wall materials while providing secure attachment without requiring extensive modification to the existing structure. The weight distribution of the cover system may be designed to prevent undue stress on wall mounting points, particularly for installations on less robust wall materials.

Environmental conditions such as temperature fluctuations, humidity levels, ultraviolet radiation, precipitation, and airborne contaminants may influence the performance and longevity of the cover system. Materials selected for the cover may be resistant to degradation from these environmental factors. For outdoor installations, the cover system may incorporate weather-resistant features such as drainage channels, moisture barriers, or UV-stabilized polymers. Indoor installations may face different challenges such as dust accumulation or incidental contact, which may be addressed through appropriate material selection and design features.

Acoustic considerations may form part of the operating environment, particularly in residential settings where charging may occur during nighttime hours. The cover system may be designed to minimize operational noise through vibration dampening properties or sound-absorbing materials. The sliding door mechanism may incorporate features to prevent excessive noise during operation, enhancing user satisfaction in noise-sensitive environments.

Maintenance requirements may be influenced by the operating environment, with different cleaning and upkeep needs based on exposure to elements, usage patterns, and aesthetic expectations. The cover system may incorporate features that facilitate maintenance, such as smooth surfaces that resist dirt accumulation, removable components for cleaning access, or materials that can be safely cleaned with common household products without degradation.

The technological environment surrounding electric vehicle charging may continue to evolve, with potential changes to charging protocols, connector designs, and/or feedback mechanisms. The cover system may incorporate a degree of future-proofing through modular design approaches that could accommodate these technological developments without requiring complete replacement of the cover system.

The cover may be provided in various aesthetic designs to suit individual preferences. For example, the cover may be styled with angular lines reminiscent of modern electric vehicle designs, with smooth curves to match contemporary home décor, or with customized graphics such as sports team logos, corporate branding, or personal artwork. The cover may be manufactured from various materials including but not limited to molded polymers, composite materials, and/or metal alloys that may provide durability while maintaining an attractive appearance.

The cover may include a main housing portion that may be configured to enclose the existing wall connector. The main housing portion may feature an angled top surface that may slope downward from back to front, creating a distinctive profile that may differentiate the charging station from its original appearance. The front face of the cover may include a recessed area that may create visual depth and may house the display slit for status indicator visibility. The sides of the cover may feature defined edges that may contribute to the overall angular aesthetic, while maintaining a compact profile that may not significantly increase the wall connector's footprint.

The interior cavity of the cover may be specifically dimensioned to accommodate the particular model of wall connector for which it may be designed. Different versions of the cover may be manufactured to fit various wall connector models, with each version maintaining the same external appearance while varying the internal dimensions and mounting provisions. Alternatively, the interior cavity may be dimensioned to accommodate various different charging stations, allowing for a single cover to be usable with multiple differing models of wall connector. The interior surface of the cover may include reinforcement ribs that may provide structural integrity while minimizing material usage and weight. These reinforcement ribs may be strategically positioned to avoid interference with the wall connector components or the light transmission system.

The cover may incorporate ventilation features that may maintain proper airflow around the enclosed wall connector. These ventilation features may include subtle openings positioned at the lower portion of the cover and along the sides, creating a natural convection path that may allow heat to dissipate during high-current charging operations. The ventilation design may be integrated with the aesthetic elements of the cover, with openings that may complement the overall design language rather than appearing as utilitarian additions.

The mounting system for the cover may include a plurality of L-shaped brackets that may be attached to the wall surrounding the existing wall connector. The upper mounting brackets may be larger than the lower mounting brackets, reflecting the different attachment methods used at the top and bottom of the cover. The upper mounting brackets may feature a horizontal surface that may extend outward from the wall, providing a platform for hook and loop material attachment. The lower mounting brackets may be more compact, with screw holes that may align with corresponding holes in the cover.

In some embodiments, installation templates may be provided with the cover to facilitate precise positioning of the mounting brackets without requiring disconnection of the wall connector. The templates may be manufactured in two parts that may be positioned around the existing wall connector, with cutouts and markings that may indicate placement for the mounting brackets. Different templates may be provided for different wall connector models, ensuring proper alignment of all functional elements regardless of the specific model being covered.

The hook and loop attachment system at the upper portion of the cover may provide several advantages over a purely mechanical fastening system. The hook and loop material may allow for slight adjustments during installation, compensating for minor variations in bracket placement. This attachment method may also distribute the load across a larger surface area, reducing stress on any single mounting point. Additionally, the hook and loop system may facilitate removal of the cover if necessary for maintenance or replacement, without requiring tools or risking damage to the wall surface.

The light transmission system may help to ensure that status information from the wall connector may remain visible to users. The light pipes may be custom-designed optical components that may be shaped to match the specific geometry of different wall connector models. The light-collecting end of each light pipe may conform to the surface of the wall connector's LED display, maximizing light capture efficiency. The light-emitting end of each light pipe may align with the display slit on the front of the cover, creating a visible status indicator that may maintain the color and pattern information from the original equipment.

The light pipes may be manufactured from optical-grade materials that may provide high light transmission efficiency with minimal color distortion. The internal surfaces of the light pipes may be designed to minimize light loss through internal reflection, ensuring that status indicators may remain clearly visible even in bright ambient lighting conditions. The light pipes may be secured within the cover using mounting provisions that may maintain proper alignment with both the wall connector and the display slit, while allowing for thermal expansion and contraction without affecting performance.

The sliding door mechanism may provide access to the connector storage area of the original wall connector without compromising the aesthetic design of the cover. The sliding door may be integrated into the side of the cover, with a track system that may guide the door along a defined path. The door may include a handle or grip feature that may facilitate opening and closing, while maintaining the design language of the overall cover. The sliding mechanism may include door stops that may prevent over-travel in either direction, ensuring reliable operation over extended use periods.

The power cable cutout at the base of the cover may be sized and positioned to accommodate the power cable entering the wall connector. This cutout may be designed with smooth edges that may prevent abrasion of the cable insulation, maintaining electrical safety. The cutout may be positioned to allow the power cable to maintain its natural bend radius, helping to reduce or prevent strain on the cable connections that could lead to premature wear or failure.

The cover may include provisions for cable management that may complement or enhance the original wall connector's capabilities. The exterior surface of the cover may be designed to facilitate proper coiling of the charging cable when not in use, with subtle contours or features that may guide the cable into an organized arrangement. Alternative cable management options may be accommodated, such as adjacent wall-mounted cable hangers or retractable cable systems, providing flexibility for different installation environments and user preferences.

The cover may be designed for indoor or outdoor installation, with materials selected to withstand the environmental conditions typically encountered in each setting. For outdoor installations, the cover may incorporate weather-resistant features such as drainage channels, moisture barriers, and/or UV-stabilized polymers that may maintain appearance and functionality despite exposure to elements. Indoor installations may benefit from dust-resistant designs and materials that may be easily cleaned with common household products.

The cover may be available in various finish options beyond the base angular design. These finish options may include different colors, textures, or surface treatments that may allow further customization to match surrounding décor or personal preferences. Special editions of the cover may feature licensed graphics, such as sports team logos, corporate branding, or artistic designs, expanding the customization possibilities beyond the structural design elements.

In commercial applications, the cover may be customized with corporate branding elements that may transform standard charging equipment into branded amenities. Hotels, restaurants, or retail establishments may utilize custom-designed covers featuring their logos, colors, or marketing messages, enhancing the perceived value of the charging service while maintaining consistent functionality across all charging stations. The modular nature of the cover system may allow for updates to branding elements without requiring replacement of the charging infrastructure.

For multi-unit residential buildings with shared charging facilities, the covers may be used to differentiate charging stations assigned to specific residents. Each unit owner may have a distinctively styled or colored cover installed over their assigned wall connector, facilitating easy identification while maintaining consistent functionality across all charging stations. The mounting system may be installed without disrupting the building's electrical infrastructure or requiring specialized electrical expertise.

The cover may be designed with consideration for end-of-life recycling or replacement. The materials selected for the cover may be recyclable, and the design may facilitate separation of different materials at end-of-life. The modular approach may allow for replacement of individual components if damaged, extending the useful life of the system. The mounting brackets may remain in place when replacing the cover, reducing waste and simplifying the update process.

The cover may be compatible with various wall connector models through the use of model-specific internal components while maintaining a consistent external appearance. This approach may allow users to maintain a cohesive aesthetic even when upgrading their charging equipment. The light pipes and mounting provisions may be tailored to specific wall connector models, while the external housing may remain standardized across the product line.

The cover may incorporate additional features beyond aesthetic enhancement, such as integrated ambient lighting that may highlight the charging station and provide practical illumination of the surrounding area. This ambient lighting may be powered independently of the wall connector, with battery operation or low-voltage connections that may not interfere with the charging functionality. The lighting may be designed to complement the overall aesthetic while providing practical benefits for nighttime use.

The cover may be designed with consideration for accessibility, ensuring that the transformation of the wall connector's appearance may not impede usability for individuals with disabilities. The height of the display slit may be positioned for optimal visibility from various viewing angles, including seated positions. The sliding door mechanism may be designed for ease of operation with minimal force requirements, accommodating users with limited dexterity or strength.

The cover may be manufactured using processes that minimize environmental impact, such as low-waste production methods, energy-efficient manufacturing, or incorporation of recycled materials where appropriate. The packaging for the cover may be designed to minimize material usage while providing adequate protection during shipping, with recyclable or biodegradable materials used where possible.

The cover may be designed to accommodate future technological developments in electric vehicle charging, with a modular approach that may allow for adaptation to new features or capabilities. The basic mounting system and cover design may remain consistent, while internal components such as light pipes or access features may be updated to match evolving wall connector designs. This forward-looking approach may extend the useful life of the cover system through multiple generations of charging equipment.

Accordingly, embodiments of the present disclosure provide a software and hardware platform comprised of a distributed set of computing elements, including, but not limited to:

### A. Housing

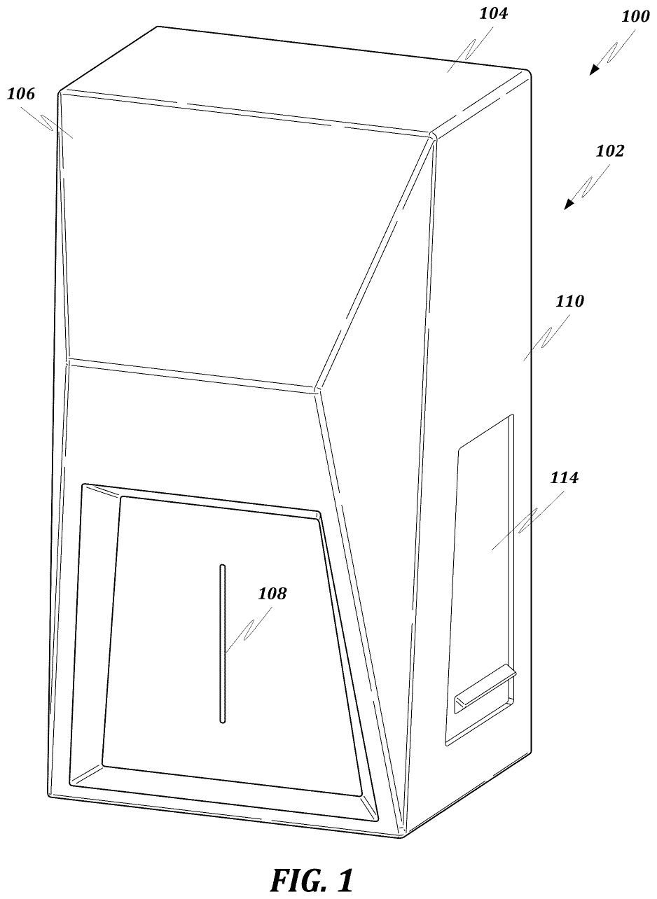

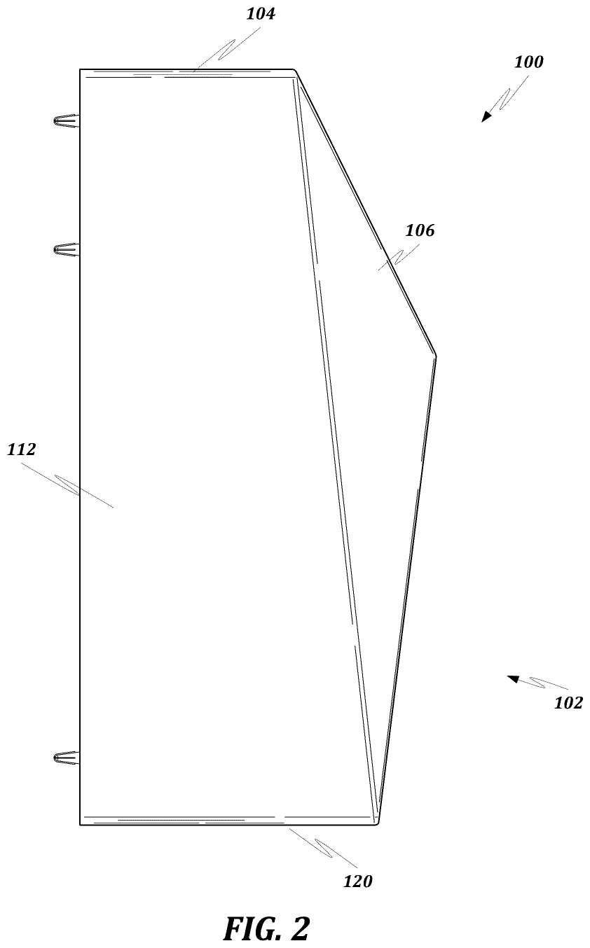

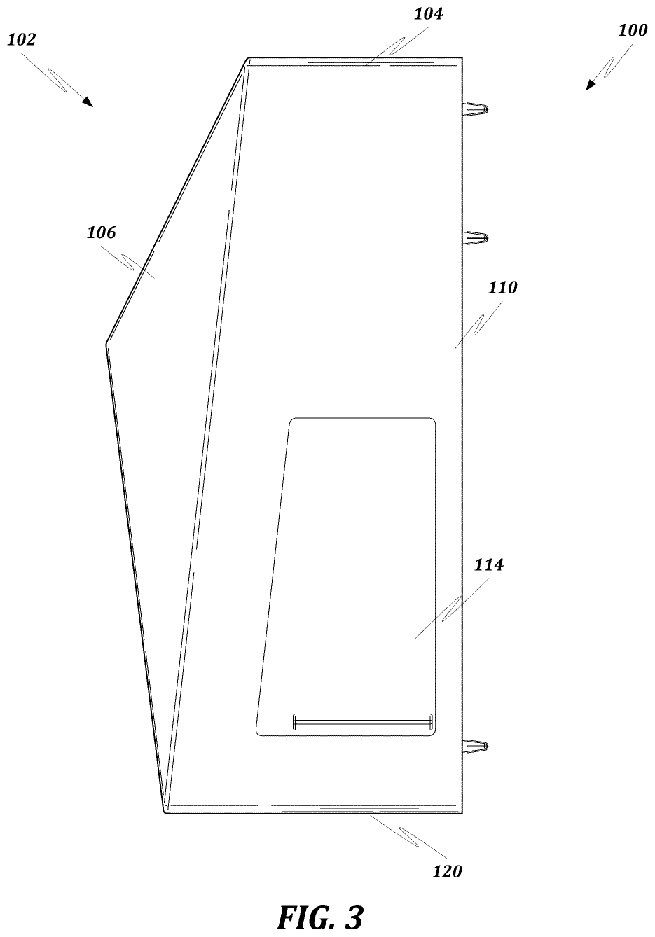

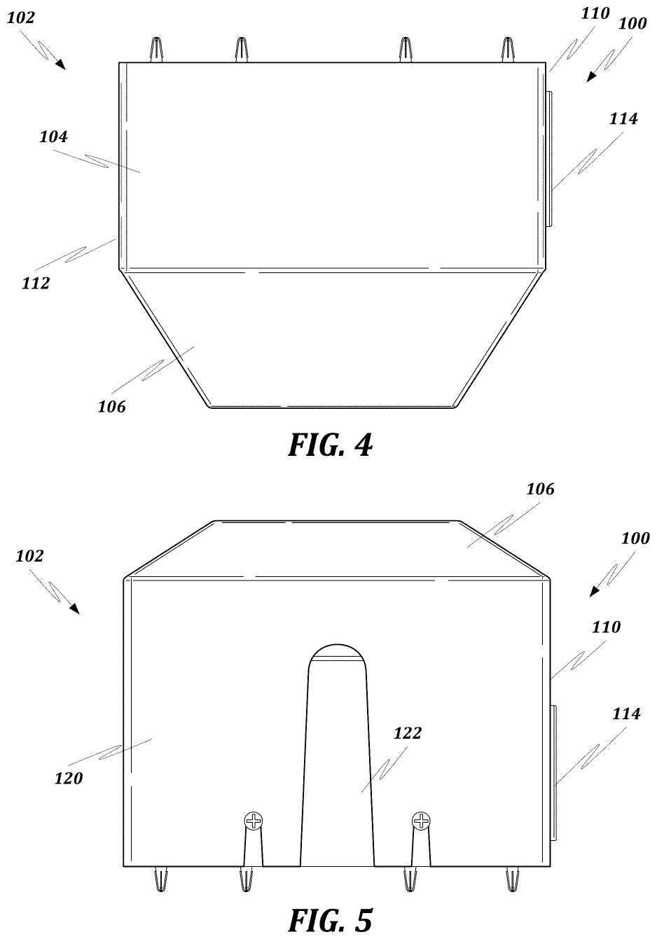

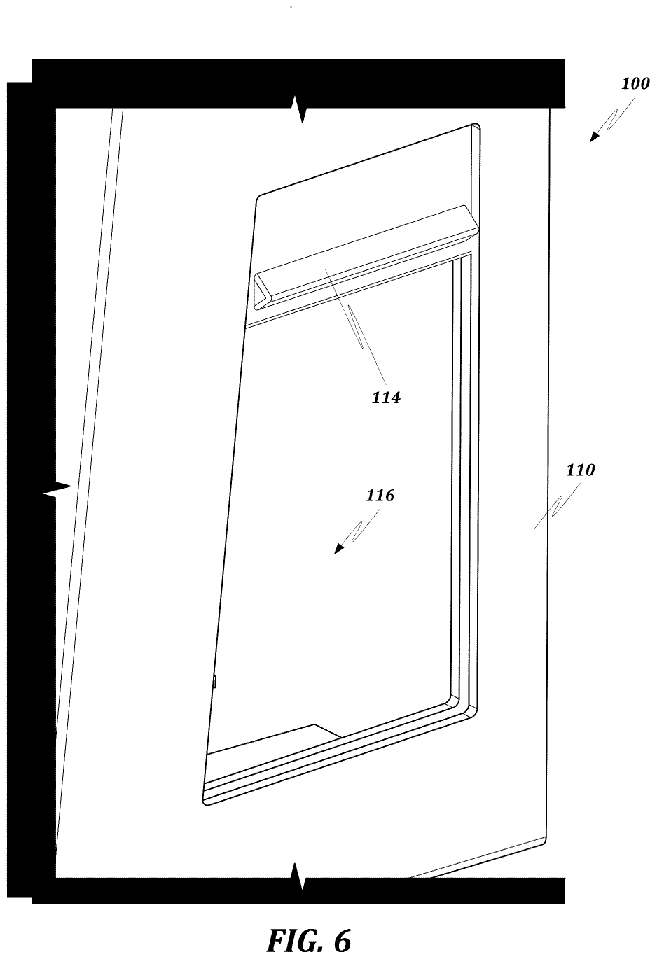

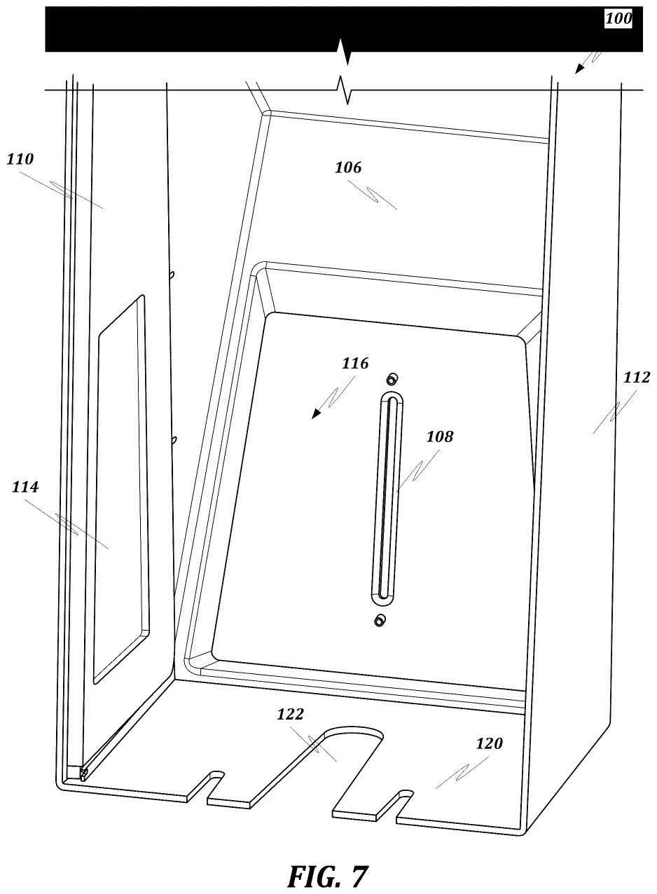

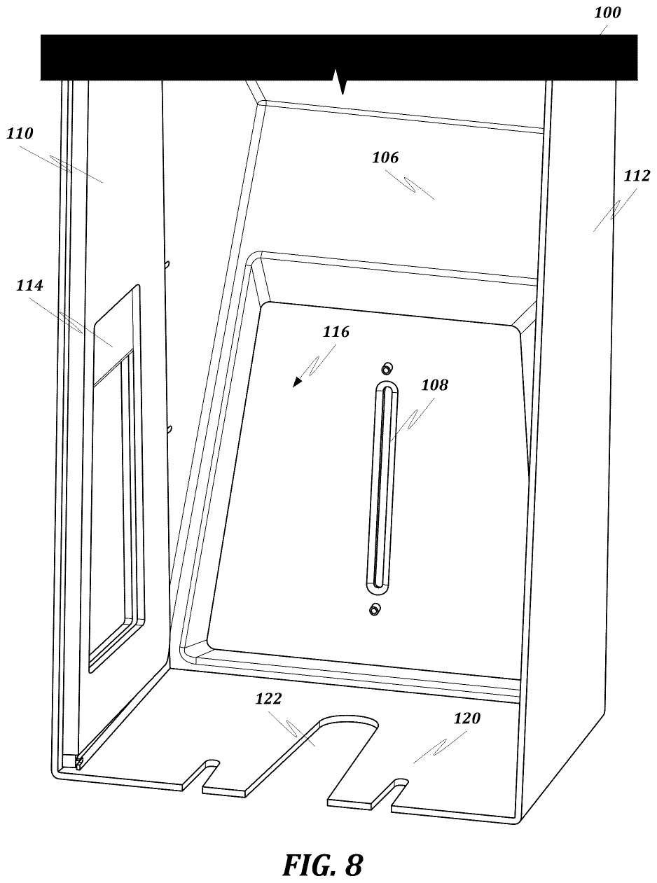

As shown in FIGS. 1-12, the cover system 100 may include a housing 102 designed to provide both aesthetic enhancement and functional preservation. The housing 102 may be constructed from durable materials such as impact-resistant polymers or composite materials that may withstand environmental exposure while maintaining an attractive appearance over time. These materials may be selected for their ability to resist ultraviolet radiation, temperature fluctuations, moisture, and/or physical impacts without degradation of appearance or structural integrity.

The housing 102 may feature an angular design language with defined edges and surfaces that may create a distinctive aesthetic reminiscent of modern electric vehicle styling. The top surface 104 of the housing 102 may be angled, sloping downward from back to front, which may create a dynamic profile while also facilitating water runoff for outdoor installations. This angled top surface 104 may be continuous with the front face 106, creating a cohesive design that may flow naturally around the enclosure.

The front face 106 of the housing 102 may include a recessed area that may create visual depth and interest. Within this recessed area, a display slit 108 may be positioned to allow visibility of the status indicator lights transmitted through the light transmission system. The dimensions and positioning of this display slit 108 may be carefully calibrated to provide visibility from typical user viewing angles while maintaining the design integrity of the front face 106.

The sides 110, 112 of the housing 102 may feature clean, defined edges that may contribute to the overall angular aesthetic. A first side 110 of the housing may incorporate the sliding door mechanism 114 that provides access to the connector storage area. This sliding door 114 may be integrated into the side profile, maintaining the design language when closed while providing functional access when opened. The door 114 may slide along tracks integrated into the housing structure, with stops that may prevent over-travel in either direction.

The interior cavity 116 of the housing 102 may be dimensioned to accommodate a wall connector. In some embodiments, the interior cavity 116 may be specifically dimensioned to accommodate a particular model of wall connector. Alternatively, the interior cavity 116 may be dimensioned to accommodate a variety of wall connectors, allowing for use with many connectors. The interior surfaces may include reinforcement ribs 118 that may provide structural integrity while minimizing material usage and weight. These reinforcement ribs 118 may be positioned to avoid interference with the wall connector components or the light transmission system. The interior cavity 116 may feature mounting provisions for securing the light transmission system in alignment with the wall connector's LED indicators and the external display slit 108.

The lower portion 120 of the housing 102 may include a cutout sized and positioned to accommodate the power cable entering the wall connector. This cutout may feature smooth edges and a generous radius to prevent abrasion of the cable insulation over time. The positioning of this cutout may allow the power cable to maintain its natural bend radius, helping to reduce strain on the cable connections.

The housing 102 may incorporate ventilation features 122 that may maintain proper airflow around the enclosed wall connector. These ventilation features 122 may include openings positioned at the lower portion 120 of the housing and/or along the sides 110, 112, creating a natural convection path that may allow heat to dissipate during high-current charging operations. The ventilation design may be integrated with the aesthetic elements of the housing, with openings that may complement the overall design language rather than appearing as utilitarian additions.

The interior surface of the upper portion 104 of the housing may include attachment areas prepared with a semi-permanent attachment device, such as hook and loop material, double-sided tape, and/or the like, for attachment to the mounting brackets 132. These attachment areas may be positioned to distribute the weight of the housing 102 evenly across the mounting points, helping to reduce or prevent stress concentration that could lead to failure over time. The lower portion 120 of the housing may include access points for fasteners (e.g., screws) that secure the housing 102 to the lower mounting brackets 134, completing the two-stage attachment system.

The exterior surface of the housing 102 may be designed to facilitate proper coiling of the charging cable when not in use. Subtle contours or features may guide the cable into an organized arrangement, reducing trip hazards and preventing excessive strain on cable connection points. These cable management features may be integrated into the aesthetic design of the housing, maintaining the clean lines and defined edges of the overall appearance.

The housing 102 may be available in various finish options beyond the base angular design. These finish options may include different colors, textures, or surface treatments that may allow further customization to match surrounding décor or personal preferences. Special editions of the housing may feature licensed graphics, such as sports team logos, corporate branding, or artistic designs, expanding the customization possibilities beyond the structural design elements.

The dimensions of the housing 102 may be carefully calculated to provide adequate clearance around the wall connector while maintaining a compact profile that may not significantly increase the wall connector's footprint. This balanced approach may ensure that the housing may enhance the appearance of the charging station without creating an obtrusive presence or requiring excessive wall space beyond what is already occupied by the original wall connector.

### B. Mounting System

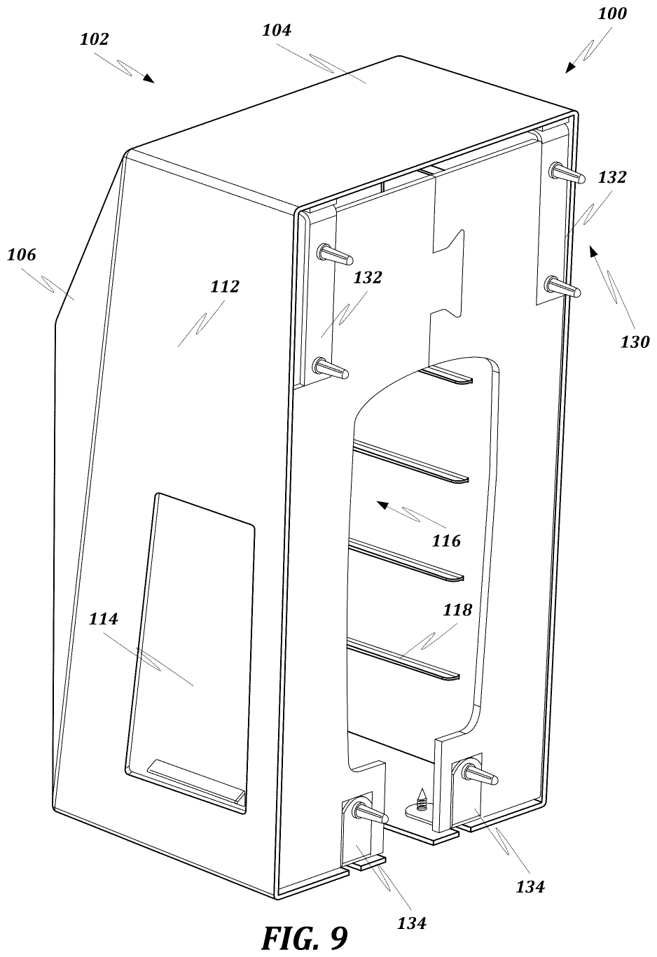

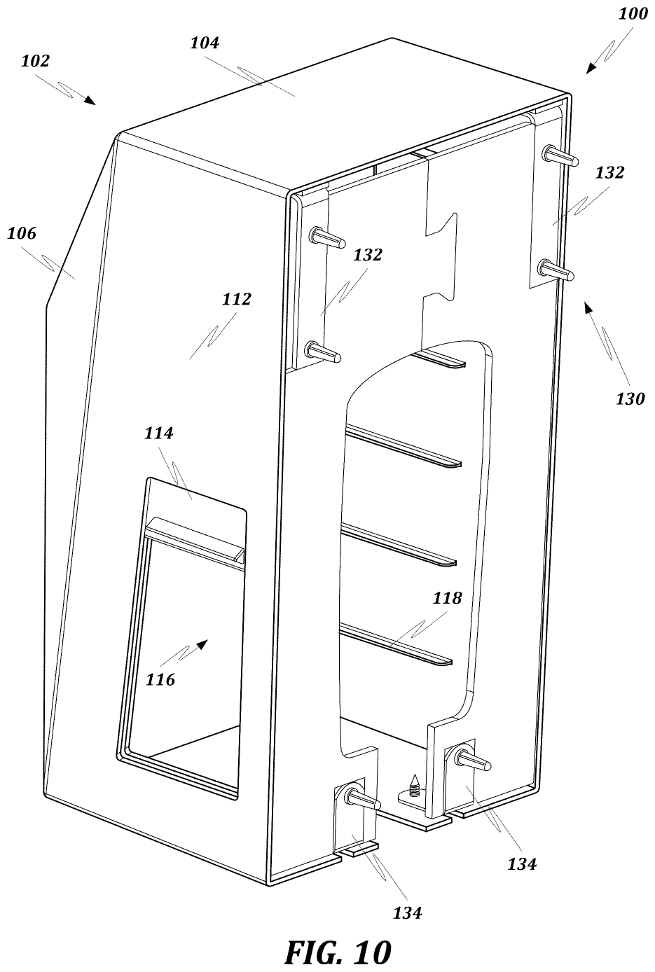

As best shown in FIGS. 9 and 10, the cover system 100 may include a mounting system 130. The mounting system 130 may include a plurality of L-shaped brackets 132, 134 designed to secure the cover 102 to a wall adjacent to the wall connector without requiring removal of the wall connector's glass cover. The mounting system 130 may be configured to provide secure attachment points for the cover 102 while maintaining proper alignment with the enclosed wall connector to ensure functionality of all components, including the light transmission system and access features.

The mounting system 130 may include at least two upper mounting brackets 132 positioned above the wall connector and at least two lower mounting brackets 134 positioned below the wall connector. This arrangement may create a balanced support structure that may distribute the weight of the cover 102 evenly across multiple attachment points, helping to reduce or prevent stress concentration at any single mounting location. The distribution of mounting brackets around the perimeter of the wall connector may also help to maintain proper alignment of the cover 102 with the enclosed wall connector, ensuring that functional elements such as the light transmission system may remain properly positioned.

The upper mounting brackets 132 may be L-shaped, with a vertical portion that may attach to the wall and a horizontal portion that may extend outward from the wall. The horizontal portion may provide a platform for attachment to the cover 102. The upper surface of the horizontal portion may be covered with a semi-permanent attachment means, such as hook and loop material, double-sided tape, and/or the like, for securing to corresponding material on the inner surface of the cover 102. This attachment method may offer several advantages, including the ability to make minor adjustments during installation, distribution of attachment forces across a larger surface area, and facilitation of removal if necessary for maintenance or replacement without requiring tools or risking damage to the wall surface.

The lower mounting brackets 134 may also be L-shaped. In some embodiment, the lower mounting brackets 134 may be smaller than the upper mounting brackets 132, reflecting the different attachment method used at the bottom of the cover 102. The lower mounting brackets 134 may include fastener holes 142 that may align with corresponding holes in the cover 102, allowing for secure attachment using mechanical fasteners. This dual attachment system—hook and loop at the top and mechanical fasteners at the bottom—may provide a secure mounting solution that may resist both pulling forces at the top and lifting forces at the bottom, helping to ensure stability of the installation over time.

The mounting brackets 132, 134 may be fabricated from durable materials such as metal or high-strength polymers that may provide long-term structural integrity. The brackets may be finished with coatings or treatments that may resist corrosion and maintain appearance over time, particularly for outdoor installations where exposure to elements may be a concern. The thickness and dimensions of the brackets may be engineered to support the weight of the cover 102 with an appropriate safety margin, while maintaining a compact profile that may not significantly increase the wall space required for the installation.

The positioning of the mounting brackets 132, 134 may be facilitated through the use of installation templates that may be provided with the cover 102. These templates may be manufactured in two parts that may be positioned around the existing wall connector, with cutouts and markings that may indicate precise placement for the mounting brackets 132, 134. Different templates may be provided for different wall connector models, ensuring proper alignment of all functional elements regardless of the specific model being covered. The templates may be designed for single use, or may be fabricated from durable materials for potential reuse in future installations.

The mounting system 130 may be designed to accommodate various wall materials and construction methods. The mounting brackets 132, 134 may include multiple mounting holes to allow for attachment to wall studs, solid masonry, or other structural elements as may be available at the installation location. The mounting hardware provided with the system may include appropriate fasteners for common wall materials, with guidance provided for selection of alternative fasteners if needed for specific installation environments.

The mounting system 130 may be engineered to maintain proper clearance between the cover 102 and the enclosed wall connector, ensuring adequate ventilation and preventing potential heat buildup during charging operations. The spacing provided by the mounting brackets 132, 134 may create an air gap that may allow for natural convection cooling of the wall connector, helping to maintain optimal operating temperatures even during high-current charging sessions.

The lower mounting brackets 134 may be positioned to align with access points in the cover 102, allowing for installation of mechanical fasteners without requiring removal of the cover 102 after initial positioning. These access points may be designed to be inconspicuous when viewed from normal angles, maintaining the aesthetic integrity of the cover 102 while providing secure attachment points. The access points may be sealed with caps or plugs after installation to maintain the clean appearance of the finished installation.

The mounting system 130 may be designed to accommodate potential future removal or replacement of the cover 102 without requiring removal of the mounting brackets 132, 134 from the wall. This approach may allow for updates to the cover design or replacement of damaged components without disrupting the mounting infrastructure. The modular nature of the mounting system 130 may extend the useful life of the installation through multiple generations of covers.

The mounting system 130 may include internal guide features that may aid in left-right alignment during installation of the cover 102. These guide features may be integrated with the mounting brackets 132, 134 or may be separate components that interact with the cover 102 during installation. The guide features may help to ensure proper positioning of the cover 102 relative to the enclosed wall connector, maintaining alignment of critical functional elements such as the light transmission system and access features.

The mounting system 130 may be designed with consideration for accessibility during installation, with brackets 132, 134 that may be positioned and secured using standard tools and without requiring specialized skills or excessive force. The templates may include clear, visual guidance for proper positioning, reducing the potential for installation errors. The two-stage attachment process—hook and loop at the top followed by mechanical fasteners at the bottom—may facilitate installation by a single person without requiring assistance to hold the cover 102 in position during attachment.

### C. Light Transmission System

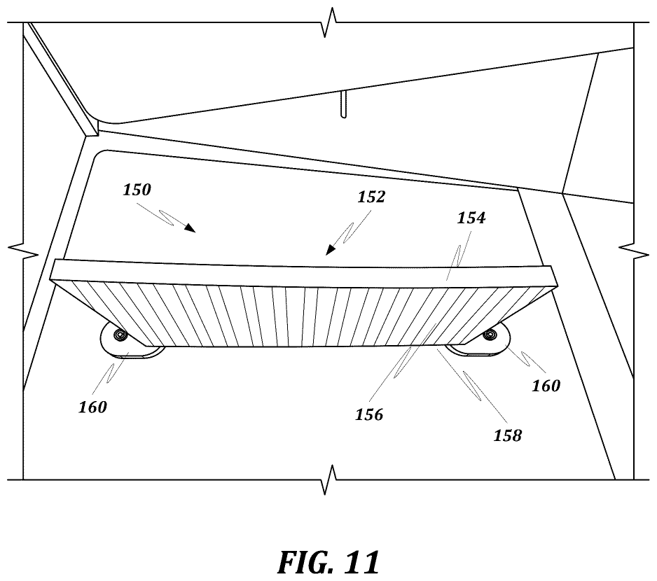

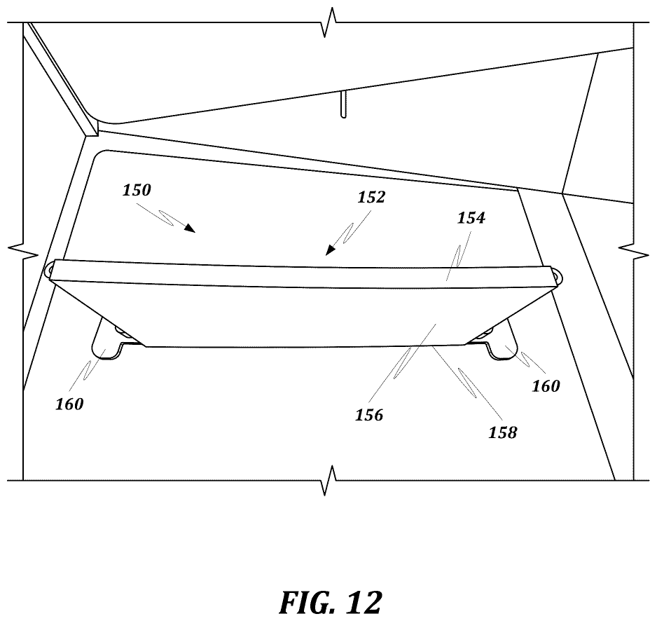

As best shown in FIGS. 11 and 12, the cover system 100 may include a light transmission system 150. The light transmission system 150 may be designed to efficiently collect and redirect status indicator lights from the wall connector to the visible exterior of the cover 102 (e.g., via the display slot 108). This system may include one or more light pipes 152 that may be custom-designed optical components shaped to match the specific geometry of different wall connector models. The light transmission system 150 may maintain the essential visual feedback function of the original wall connector while integrating it into the new aesthetic design of the cover 102.

The light pipes 152 may be fabricated from optical-grade materials such as acrylic or polycarbonate that may provide high light transmission efficiency with minimal color distortion. These materials may be selected for their optical clarity, durability, and resistance to yellowing or degradation over time. The light pipes 152 may be transparent or may include subtle tinting that may complement the LED colors without significantly altering their appearance or visibility.

Each light pipe 152 may feature a light-collecting end 154 that may be shaped to conform to a portion of the surface of the wall connector's LED display. This custom shaping may increase or maximize light capture efficiency by maintaining direct contact with the light source surface. The light-collecting end 154 may be polished to optical quality to minimize light loss at the collection interface. For wall connectors with multiple LED indicators, the light-collecting ends 154 of the light pipes 152 may be configured to capture light from all relevant indicators simultaneously.

The one or more light pipes 152 may include an elongated transmission section 156 that may conduct the collected light from the wall connector (e.g., at the light collecting end 154) to the front of the cover 102 (e.g., at the display slit 108). This transmission section 156 may be designed to reduce or minimize light loss through internal reflection, helping to ensure that status indicators may remain clearly visible even in bright ambient lighting conditions. The geometry of the transmission section 156 may be optimized to maintain signal integrity while navigating the spatial constraints within the cover 102.

The light-emitting end 158 of each light pipe 152 may align with the display slit 108 on the front of the cover 102. This alignment may help to ensure that status information may be clearly visible to users. The light-emitting end 158 may be shaped to create a uniform light distribution across the display slit 108, avoiding hot spots or dark areas that could reduce visibility or clarity of the status information. The surface finish of the light-emitting end 158 may be engineered to provide appropriate light diffusion for optimal visibility from various viewing angles.

Each of the one or more light pipes 152 may be secured within the cover 102 using mounting provisions 160 that may maintain proper alignment with both the wall connector and the display slit 108. These mounting provisions 160 may include clips, brackets, or other attachment methods that may secure the light pipes 152 while allowing for thermal expansion and contraction without affecting performance. The mounting system may be designed to reduce or prevent light leakage around the edges of the light pipes 152, which could reduce the contrast and visibility of the status indicators.

As shown in FIG. 11, for wall connectors with sequential lighting patterns or color-changing indicators, the light transmission system 150 may be designed to preserve these dynamic visual cues. The optical properties of the light pipes 152 may be selected to maintain color fidelity across the spectrum of indicator colors used by the wall connector. This preservation of color information may be critical for users familiar with the meaning of different indicator colors in the original wall connector. As shown in FIG. 12, a single light pipe may be used to refract and distribute light collected from an LED over a larger portion (e.g., the entirety) of the display slit 108.

The light transmission system 150 may be engineered to accommodate various lighting conditions. For outdoor installations where the cover 102 may be exposed to direct sunlight, the display slit 108 may be recessed or shaded to improve contrast and visibility of the transmitted light. For indoor installations with lower ambient light levels, the light transmission system 150 may be optimized to provide clear visibility without excessive brightness that could be distracting in darkened environments.

The light pipes 152 may be manufactured using processes that ensure high optical quality and dimensional precision. These processes may include injection molding with optical-grade materials, precision machining of critical surfaces, and polishing operations to achieve the required surface finish. Quality control measures may be implemented to verify the optical performance of each light pipe 152 before installation in the cover 102.

The light transmission system 150 may be designed with consideration for long-term reliability. The materials and mounting methods may be selected to maintain alignment and optical performance over years of use, despite potential exposure to temperature fluctuations, vibration, or other environmental factors. The system may be sealed against dust intrusion, which could accumulate on optical surfaces and reduce light transmission efficiency over time.

For wall connectors with multiple status indicators arranged in specific patterns, the light transmission system 150 may be configured to maintain the spatial relationship between these indicators when displayed through the display slit 108. This preservation of indicator patterns may be important for users who rely on the specific arrangement of lights to quickly assess charging status or identify potential issues.

The light transmission system 150 may include provisions for potential future updates or replacements. The light pipes 152 may be designed as modular components that could be replaced individually if damaged or if updates to the wall connector change the configuration of the status indicators. This modular approach may extend the useful life of the cover 102 through multiple generations of wall connector designs.

### III. Platform Operation

The methods described herein may be performed by one or more individuals, entities, devices, components, systems, or combinations thereof. The various steps, operations, or processes of the methods disclosed herein may be performed by one or more actors, which may include users, installers, manufacturers, service providers, or any other suitable party. The methods may be implemented in any suitable order, sequence, or arrangement, and the specific ordering of steps presented herein should not be construed as limiting the scope of the methods or their implementation.

The methods may be performed in various sequences, and the order of steps may be rearranged, modified, omitted, or supplemented without departing from the scope of the disclosure. Steps from different methods may be combined, performed simultaneously, or integrated to create new methods not explicitly described herein. Any step or series of steps may be performed by a single actor or distributed among multiple actors. For example, installation steps may be performed by a professional installer, a homeowner, or a combination of both parties working together.

Some steps of the methods may be optional depending on the specific implementation or user preferences. Alternative techniques or approaches may be substituted for certain steps while still achieving substantially similar results. The methods may be scaled or adapted to suit different installation environments, wall materials, or space constraints.

The methods may be performed once during initial installation or may be repeated during maintenance, replacement, or upgrading of components. Certain steps may be performed periodically or as needed to maintain proper functionality of the system. The methods may be documented in user manuals, installation guides, or other instructional materials to facilitate proper implementation.

The methods may be performed by individuals with varying levels of technical expertise. While certain steps may benefit from specialized knowledge, the methods may be designed to be accessible to users without extensive technical training. The methods may include safety precautions or warnings to help ensure proper implementation without creating hazards.

Different actors may perform different portions of the methods based on their respective roles, responsibilities, or expertise. For example, a manufacturer may perform certain preparation steps, while an installer may perform on-site installation steps, and an end user may perform operational steps. The methods may be communicated between these actors through documentation, training, or other means of knowledge transfer.

### A. Master Method

The installation process for the cover may be designed to be completed by users without specialized tools or technical expertise. The process may begin with selection of the appropriate template corresponding to the specific model of wall connector to be covered. The template may be positioned on the wall surrounding the existing wall connector, providing guidance for bracket placement. The L-shaped mounting brackets may be installed according to the template, with the upper brackets positioned above the wall connector and the lower brackets positioned below.

Once the brackets may be securely mounted to the wall, hook and loop material may be applied to the top surface of the upper brackets if not pre-installed. The cover, with the light pipes already installed in their proper positions, may be aligned with the mounted brackets and pressed against the wall. The cover may then be slid downward slightly to engage the hook and loop attachment at the top. The lower portion of the cover may be secured with screws through the designated access points, completing the mechanical installation without requiring modification to the wall connector itself.

After installation, the cover may transform the appearance of the wall connector while maintaining all functional aspects. The status indicator lights may be visible through the display slit on the front of the cover, transmitted by the light pipes from the original LED display. The charging connector may be accessible through the sliding door on the side of the cover, maintaining the original storage functionality. The charging cable may be managed through coiling around the cover or alternative methods according to user preference. The power connection to the wall connector may remain undisturbed, with the cable properly accommodated by the cutout at the base of the cover.

The cover may be removed if necessary for maintenance or replacement without requiring disconnection of the wall connector from power sources. The removal process may begin with loosening the screws at the lower portion of the cover. Once the lower portion may be free, the cover may be lifted slightly to disengage the hook and loop attachment at the top. The entire cover may then be pulled away from the wall, leaving the wall connector and mounting brackets in place. This reversible installation method may preserve manufacturer warranties and safety certifications of the original wall connector while providing aesthetic flexibility.

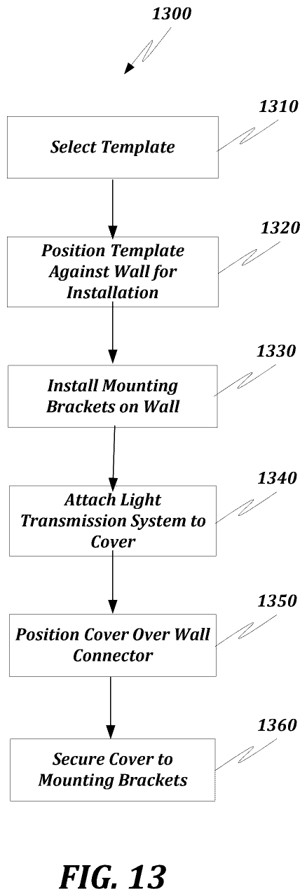

FIG. 13 is a flow chart setting forth the general stages involved in a method 1300 consistent with an embodiment of the disclosure for installing the cover system 100. Method 1300 may begin at stage 1310 where an appropriate template corresponding to the specific model of wall connector to be covered is selected. The template may be provided as part of the cover system and may include cutouts and markings specifically designed for the particular wall connector model. This selection process may ensure proper alignment of all functional elements during installation.

The template may be selected from a plurality of templates based on a model of the wall connector. Different wall connector models may have varying dimensions, mounting configurations, and positions for functional elements such as LED indicators and connector storage areas. The selection of the appropriate template may help to ensure that the mounting brackets may be positioned correctly for the specific wall connector model being covered, maintaining proper alignment of all functional elements.

At stage 1320, the selected template may be positioned against a wall adjacent to the electric vehicle wall connector without disconnecting the wall connector from its power source. This non-invasive approach may preserve the electrical safety of the installation and may maintain the wall connector's warranty coverage. The template may be provided in two parts that may be positioned around the existing wall connector, allowing for accurate placement without requiring removal of the wall connector from the wall.

A plurality of mounting brackets may be installed on the wall according to guidance from the template in stage 1330. The mounting brackets may include at least two upper mounting brackets positioned above the wall connector and at least two lower mounting brackets positioned below the wall connector. This arrangement may create a balanced support structure that may distribute the weight of the cover evenly across multiple attachment points.

The mounting brackets may be secured to the wall using appropriate fasteners for the specific wall material. For drywall installations, the brackets may be anchored to wall studs where possible, or appropriate wall anchors may be used to ensure secure attachment. For masonry or concrete walls, masonry-specific fasteners may be employed. The template may provide guidance for proper positioning of the brackets relative to the wall connector, ensuring that the cover may properly align with the enclosed wall connector when installed.

At stage 1340, a light transmission system may be attached to an inside surface of the cover if not pre-installed. The light transmission system may include one or more light pipes configured to collect light emissions from light emitting diodes of the wall connector. The light transmission system may be secured within the cover using mounting provisions that may maintain proper alignment with both the wall connector and the display slit.

The cover may be positioned over the wall connector at stage 1350, such that the light transmission system aligns with the light emitting diodes of the wall connector. This alignment may be facilitated by the mounting brackets which may be positioned according to the template to ensure proper positioning of the cover relative to the wall connector. The cover may be carefully aligned to ensure that all functional elements, including the light transmission system 150 and access features, may properly interact with the corresponding elements of the wall connector.

The light pipe used in the installation may be configured to conform to a specific surface geometry of the wall connector. Different wall connector models may have varying LED indicator configurations, and the light pipe may be specifically designed to match the particular model being covered. This custom shaping may maximize light capture efficiency and may ensure proper transmission of status information to the display slit on the cover.

The cover may be secured to the plurality of mounting brackets at stage 1360. Securing may use a two-stage attachment process. This process may begin with pushing the cover against the wall, positioning it slightly above its final position. The cover may then be slid downward to connect hook and loop material on an inner surface of the cover with corresponding hook and loop material on the at least two upper mounting brackets. This sliding motion may engage the hook and loop fastening system, providing secure attachment at the upper portion of the cover.

After engaging the hook and loop attachment at the top, screws may be inserted through access points in the cover to secure the cover to the at least two lower mounting brackets. These access points may be designed to be inconspicuous when viewed from normal angles, maintaining the aesthetic integrity of the cover while providing secure attachment points. The access points may be sealed with caps or plugs after installation to maintain the clean appearance of the finished installation.

Following the physical installation, the functionality of the cover system may be verified by checking that status information from the wall connector may be visible through the cutout slit in the cover via the light transmission system. This verification may include confirming that the light transmission system effectively collects and transmits light from the wall connector's LED indicators to the display slit, maintaining visibility of status information. The verification may also include checking that the color and pattern of status indicators is preserved through the light transmission system.

Throughout the installation process, the cover may be installed without removing any portion of the wall connector or disconnecting the electrical connection of the wall connector. This non-invasive approach may preserve the electrical safety of the installation and may maintain the wall connector's warranty coverage. By avoiding disassembly of the wall connector, the installation method may be accessible to users without specialized electrical knowledge or tools, reducing the barrier to aesthetic customization.

In some embodiments, the method 1300 may further include operating a sliding door mechanism integrated with the cover to access a vehicle connector storage area of the wall connector. This operation may confirm that the sliding door moves smoothly along its track and provides adequate access to the connector storage area. The sliding door may be operated multiple times to ensure reliable function and to verify that the door stops prevent over-travel in either direction.

The method 1300 may optionally include additional steps for cable management after installation of the cover. The charging cable may be coiled around the exterior of the cover, utilizing subtle contours or features that may guide the cable into an organized arrangement. Alternatively, the cable may be managed through adjacent wall-mounted cable hangers or other management systems according to user preference. The method may include verifying that the cable may be properly routed without creating strain on connection points or presenting trip hazards.

For outdoor installations, the method 1300 may include additional verification steps to ensure weather resistance. These steps may include checking that the cover is properly sealed against water intrusion at mounting points and that ventilation features are positioned to prevent water accumulation while maintaining proper airflow. The installation in outdoor environments may also include verification that all materials and finishes may be suitable for exposure to elements such as ultraviolet radiation, precipitation, and temperature fluctuations.

The method 1300 may optionally include documentation of the installation for future reference. This documentation may include recording the specific model of wall connector covered, the template used for bracket positioning, and any adjustments made during installation. This information may be valuable for potential future maintenance, replacement, or upgrading of components. The documentation may also include warranty information and guidance for care and maintenance of the cover.

For installations in commercial or multi-unit residential settings, the method 1300 may optionally include additional steps for identification or branding. These steps may include applying custom graphics, logos, or identification markers to the cover. For charging stations assigned to specific users or units, clear identification may be applied to facilitate proper usage and prevent confusion in shared charging areas.

### VI. Claims

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as examples for embodiments of the disclosure.

Insofar as the description above and the accompanying drawing disclose any additional subject matter that is not within the scope of the claims below, the disclosures are not dedicated to the public and the right to file one or more applications to claims such additional disclosures is reserved.

The following is claimed:

1. A system for enhancing an electric vehicle charging apparatus, the system comprising:
a cover configured to enclose an electric vehicle wall connector without compromising functionality of the wall connector;
a plurality of mounting brackets configured to secure the cover to a wall adjacent to the wall connector without requiring removal of a glass cover of the wall connector;
at least one light pipe configured to collect light emissions from light emitting diodes of the wall connector and transmit the light emissions to a visible exterior portion of the cover; and
a sliding door mechanism integrated with the cover, the sliding door mechanism providing access to a vehicle connector storage area of the wall connector.

2. The system of claim 1, wherein the plurality of mounting brackets comprise:
at least two upper mounting brackets positioned above the wall connector; and
at least two lower mounting brackets positioned below the wall connector.

3. The system of claim 2, wherein the at least two upper mounting brackets are L-shaped and comprise a hook and loop material on a top surface for securing to a corresponding hook and loop material on an inner surface of the cover.

4. The system of claim 1, wherein the cover comprises a cutout slit configured to display status information from the wall connector through the at least one light pipe.

5. The system of claim 1, wherein the cover comprises a power conductor cutout configured to accommodate a power cable connected to the wall connector.

6. The system of claim 1, wherein the at least one light pipe is configured to conform to a specific surface geometry of the wall connector.

7. The system of claim 1, wherein the cover is configured to maintain proper ventilation and thermal management for the enclosed wall connector.

8. The system of claim 1, further comprising at least one access point for securing the cover to the plurality of mounting brackets with screws.

9. A system for customizing an appearance of an electric vehicle charging station, the system comprising:
a wall-mountable enclosure having an angular design;
a plurality of L-shaped mounting brackets configured to secure the enclosure to a wall surface without requiring disassembly of an electric vehicle wall connector;
a light transmission assembly comprising at least one light pipe configured to redirect status indicator lights from the wall connector to a viewing slot on the enclosure; and
an access door integrated into a side of the enclosure, the access door being slidable to provide access to a charging cable connector storage area.

10. The system of claim 9, wherein the enclosure comprises:
an angled top surface;
a front face having a recessed area; and
side panels with defined edges.

11. The system of claim 9, wherein the light transmission assembly maintains color fidelity of status indicators through the at least one light pipe.

12. The system of claim 9, wherein the enclosure comprises cable management features configured to facilitate coiling of a charging cable around an exterior of the enclosure.

13. The system of claim 9, wherein the plurality of L-shaped mounting brackets comprise:
a first set of brackets positioned at an upper portion of the wall connector; and
a second set of brackets positioned at a lower portion of the wall connector.

14. The system of claim 13, wherein the first set of brackets comprise hook and loop fastening material for securing to corresponding hook and loop fastening material on an interior surface of the enclosure.

15. The system of claim 9, further comprising at least two screw holes positioned at a lower portion of the enclosure, the screw holes configured to align with the second set of brackets for securing the enclosure to the wall surface.

16. A system for retrofitting an electric vehicle wall charging unit, the system comprising:
a housing having an interior cavity sized to accommodate an existing wall-mounted electric vehicle charging unit;
a mounting assembly comprising:
a plurality of upper L-shaped brackets configured to be secured to a wall above the charging unit;
a plurality of lower brackets configured to be secured to the wall below the charging unit; and
fastening elements configured to secure the housing to the mounting assembly;
a light transmission system comprising at least one light conduit configured to transmit status indicator lights from the charging unit to a viewing area on the housing; and
a movable access panel integrated with the housing, the movable access panel providing access to a charging connector storage area of the charging unit.

17. The system of claim 16, wherein the housing comprises:
an angled top surface;
a front face having a vertical slot aligned with the light transmission system; and
a cutout portion at a lower region configured to accommodate a power cable entry point.

18. The system of claim 16, wherein the fastening elements comprise:
hook and loop material on the upper L-shaped brackets and corresponding hook and loop material on an interior surface of the housing; and
screw fasteners configured to secure the housing to the lower brackets through access holes in the housing.

19. The system of claim 16, wherein the light transmission system is configured to maintain visibility of sequential lighting patterns from the charging unit.

20. The system of claim 16, wherein the housing is configured to be installed without removing a glass cover of the charging unit and without disconnecting the charging unit from electrical power.
